(19) United States
(12) Patent Application Publication
(10) Pub. No.: US 2005/0087019 A1
(43) Pub. Date: Apr. 28, 2005

(54) Self-powered vibration monitoring system

(76) Inventor: Bradbury R. Face, Norfolk, VA (US)

Correspondence Address: David J. Bolduc;Face International Corporation, 427 W 35th St, Norfolk, VA, 23508, US

(21) Appl. No.: 10/972,818

(22) Filed: Oct. 25, 2004

Related U.S. Application Data
(60) Provisional application No. 60/514,256, filed on Oct. 24, 2003.

(51) Int. Cl. G01N 29/00

(52) U.S. Cl. 73/649

(57) ABSTRACT

A system for monitoring the vibration of electrical and mechanical equipment. More particularly, the present invention relates to a self-powered vibration monitoring device and system that generates an electrical signal that not only powers the device(s), but also is indicative of the frequency and/or amplitude of vibration of the equipment to which it is attached. The power is preferably generated through a piezoelectric element and is sent through signal generation circuitry coupled to a transmitter for sending RF signals indicative of the vibrational status of the equipment to one or more receivers for further display or processing.

This application claims the benefit of priority under 35 U.S.C. 119(e) from U.S. Provisional Application 60/514,256 filed on Oct. 10, 2003.

### BACKGROUND OF THE INVENTION

1. Field of the Invention

The present invention relates generally to devices for monitoring the vibration of electrical and mechanical equipment. More particularly, the present invention relates to a self-powered vibration monitoring device and system that generates an electrical signal that not only powers the device(s), but also is indicative of the frequency and/or amplitude of vibration of the equipment to which it is attached. The power is preferably generated through a piezoelectric element and is sent through signal generation circuitry coupled to a transmitter for sending RF signals indicative of the vibrational status of the equipment to one or more receivers for further display or processing.

2. Description of the Prior Art

Vibration is considered the best operating parameter to judge dynamic conditions such as balance, bearing defects and proper lubrication of rotary elements in bearings, AC and DC motors, pumps, gearboxes, compressors, fans and the like. Therefore, tools have been designed to monitor and analyze trends in overall vibration readings in rotary and linear process equipment and machines susceptible to vibration. These tools are used in predictive and condition-based maintenance programs as well as being added into existing maintenance programs using data collection and analysis software.

Vibrational monitoring sensors, gauges and the like are known in the prior art. Typical vibrational monitoring sensors measure, for example, displacement, velocity and/or acceleration. Examples include seismic vibration transmitters manufactured by Metric Instrument Co. which comprise accelerometer type vibration sensors and signal conditioners for sensing vibration levels. A 4-20 mA signal proportional to velocity or displacement is transmitted directly to a programmable logic controller (PLC) distributed control system (DCS) or other 4-20 mA input monitor. The transmitter is mounted into a tapped hole in the machine case, and two wires are connected into a 4-20 mA current loop, allowing the sensor to transmit the machine's vibration level. Some models feature a local LCD digital indicator installed with transmitters employing a solid-state accelerometer sensor.

Other designs include accelerometers of the type manufactured by Silicon Designs, Inc. These include surface mounted, single and multiple axis accelerometer modules incorporated into data acquisition systems. Single axis and triaxial accelerometers can have a digital pulse density output, a differential voltage output or a single ended voltage output. Models having a buffered differential or single ended voltage output with an internal voltage regulator and reference use +9 to +30 VDC power. The outputs of the single axis or triaxial accelerometer modules may be input into a data acquisition system which connects to PC via serial port for programming & data reporting. The data acquisition system typically logs acceleration, shock, vibration, velocity and temperature and has programmable data capture for timed, continuous or event centered capture. The data acquisition system typically runs on D-Cell batteries that allow up to 3 weeks of independent operation.

In each of these vibration monitoring schemes it is often necessary to run cable between the vibration monitoring devices on the equipment and the data acquisition equipment. It is also often necessary to run cable from an external power source to the vibration monitoring devices and the data acquisition equipment. In other devices it is necessary to provide a power source in the form of batteries. In each of these schemes wherein cables are run between equipment located in different areas, it is often necessary to drill holes in walls and mount switches and junction boxes as well as running cable. Drilling holes and mounting switches and junction boxes can be difficult and time consuming. Also, running electrical cable requires starting at a fixture, pulling cable through holes in the framing to each fixture in a circuit, and continuing back to a service panel. Though simple in theory, getting cable to cooperate can be difficult and time consuming. Cable often kinks, tangles or binds while pulling, and needs to be straightened out somewhere along the run. Practically, cables also take up a significant amount of space, particularly in areas where space is at a premium such as in aircraft, ships, submarines and in factories and process plants.

Remote actuation controllers are also known in the art. Known remote actuation controllers include tabletop controllers, wireless remotes, timers, motion detectors, voice activated controllers, and computers and related software. For example, remote actuation means may include modules that are plugged into a wall outlet and into which a power cord for a device may be plugged. The device can then be turned on and off by a controller. Other remote actuation means include screw-in lamp modules wherein the module is screwed into a light socket, and then a bulb screwed into the module. The light can be turned on and off and can be dimmed or brightened by a controller.

An example of a typical remote controller for the above described modules is a radio frequency (RF) base transceiver. With these controllers, a base is plugged into an outlet and can control groups of modules in conjunction with a hand held wireless RF remote. RF repeaters may be used to boost the range of compatible wireless remotes, switches and security system sensors by up to 150 ft. per repeater. The base is required for all wireless RF remotes and allows control of several lamps or appliances. Batteries are also required in the hand held wireless remote.

A problem with conventional vibration monitoring systems is that extensive wiring must be run between switch boxes, service panels, vibration sensors and vibration analysis devices.

Another problem with conventional vibration monitoring systems is the cost associated with initial installation of wire or cable to, from and between switch boxes, vibration sensors and vibration analysis devices.

A problem with conventional vibration monitoring systems is that they require an external power source such as high voltage AC power or batteries.

Another problem with conventional vibration monitoring systems is the cost and inconvenience associated with replacement of batteries.

Another problem with conventional vibration monitoring systems is that they require high power to individual modules.

A problem with using RF controllers or adapters for vibration monitoring systems is that a pair comprising a transmitter and receiver must generally be purchased together.

Another problem with using RF controllers or adapters for vibration monitoring systems is that transmitters may inadvertently activate incorrect receivers.

Another problem with using RF controllers or adapters for vibration monitoring systems is that receivers may accept an activation signal from only one transmitter.

Another problem with using RF controllers or adapters for vibration monitoring systems is that transmitters may activate only one receiver.

Accordingly, it would be desirable to provide a vibration monitoring system that overcomes the aforementioned problems of the prior art.

### SUMMARY OF THE INVENTION

The present invention provides a self-powered vibration monitoring system using an electroactive actuator and associated circuitry. The piezoelectric element in the electroactive actuator is capable of deforming with a significant amount of axial displacement, and when deformed, e.g., by a vibrational or other mechanical impulse, generates an electric field. The electroactive actuator is used as an electromechanical generator for generating an electrical signal that initiates a latching or relay mechanism. The latching or relay mechanism thereby turns electrical devices such as lights and appliances on and off or provides an intermediate or dimming signal.

The electroactive actuator element is mounted to a piece of equipment that is subject to vibration, and which vibration is transmitted to the actuator. The equipment applies a vibrational impulse to the electroactive actuator element in order to generate an oscillating electrical signal having sufficient magnitude to actuate downstream circuit components. Larger or multiple electroactive actuator elements may also be used to generate the electrical signal. The accompanying circuitry designed to work with an oscillating electrical signal to harness the power generated by the electroactive element, and the accompanying RF signal generation circuitry is configured to use the oscillating electrical signal most efficiently.

In one embodiment of the invention, the electroactive actuator signal powers an RF transmitter which sends an RF signal to an RF receiver which sends the received signal to the vibration display or analysis device. In yet another embodiment, digitized RF signals may be coded (as with a garage door opener) so that only the receiver that is coded with that digitized RF signal may intercept the transmitted signal. The transmitters may be capable of developing one or more coded RF signals and the receivers likewise may be capable of receiving one or more coded RF signal. Furthermore, the receivers may be “trainable” to accept coded RF signals from new or multiple transmitters. This allows a single processor to receive multiple coded signals on discreet channels corresponding to the equipment to which a sensor is mounted.

Copending application Ser. No. 09/616,978 entitled “Self-Powered Switching Device,” which is hereby incorporated by reference, discloses a self-powered switch where the electroactive element generates an electrical pulse. Copending provisional application 60/252,228 entitled “Self-Powered Trainable Switching Network,” which is hereby incorporated by reference, discloses a network of switches such as that disclosed in the application Ser. No. 09/616,978, with the modification that the switches and receivers are capable accepting a multiplicity of coded RF signals.

Accordingly, it is a primary object of the present invention to provide a self powered vibration monitoring system in which an electroactive or piezoelectric element is used to activate the device.

It is another object of the present invention to provide a device of the character described in which self powered vibration monitoring devices and analysis equipment may be installed without necessitating additional wiring.

It is another object of the present invention to provide a device of the character described in which vibration monitoring devices do not require external electrical input such as batteries.

It is another object of the present invention to provide a device of the character described incorporating an electroactive actuator that generates an electrical signal of sufficient magnitude to activate a radio frequency transmitter.

It is another object of the present invention to provide a device of the character described incorporating a transmitter that is capable of developing at least one coded RF signal.

It is another object of the present invention to provide a device of the character described incorporating a receiver capable of receiving at least one coded RF signal from at least one transmitter.

It is another object of the present invention to provide a device of the character described incorporating a receiver capable of “learning” to accept coded RF signals from one or more transmitters.

Further objects and advantages of the invention will become apparent from a consideration of the drawings and ensuing description thereof.

### BRIEF DESCRIPTION OF THE DRAWINGS

FIG. 1 is an elevation view showing the details of construction of a flextensional piezoelectric transducer used in the present invention, as an electroactive generator;

FIG. 1a is an elevation view showing the details of construction of the flextensional piezoelectric generator of FIG. 1 having an additional prestress layer;

FIG. 2 is an elevation view showing the details of construction of an alternate multi-layer flextensional piezoelectric generator used in a modification of the present invention;

FIG. 2a is an elevation view showing the details of construction of the flextensional piezoelectric generator of FIG. 1a with a flat rather than arcuate profile;

FIG. 2b is an elevation view showing a multilayer flextensional piezoelectric generator of FIG. 2 having a cofired rather than adhesive construction;

FIG. 3 is an elevation view of an embodiment of a device for mounting to a vibrating piece of equipment;

FIG. 4 is an elevation view of another embodiment of a device for mounting to a vibrating piece of equipment, having an attached mass;

FIG. 5 is an elevation view of the device of FIG. 3 illustrating the deformation of the electroactive generator upon application of a force or vibration;

FIG. 6 is an elevation view another embodiment of a device for mounting to a vibrating piece of equipment and using a flat piezoelectric element;

FIGS. 7a-c are elevation views of the device of FIG. 6 illustrating the deflection a electroactive generator of FIG. 2a upon application of a force or vibration;

FIG. 8 is a block diagram showing the components of a circuit for using the electrical signal generated by the device of FIGS. 3-7;

FIG. 9 is a block diagram showing the components of an alternate circuit for using the electrical signal generated by the device of FIGS. 3-7;

FIGS. 10a-c show the electrical signal generated by the actuator, the rectified electrical signal and the regulated electrical signal respectively, when vibrating for a short duration;

FIG. 11 is a plan view of a tuned loop antenna of FIG. 8 or 9 illustrating the jumper at a position maximizing the inductor cross-section;

FIG. 12 is a plan view of the tuned loop antenna of FIG. 8 or 9 illustrating the jumper at a position minimizing the inductor cross-section;

FIG. 13 is a partial schematic circuit diagram showing the components of the transmitter circuit of FIG. 8;

FIG. 14 is a partial schematic circuit diagram showing the components of the transmitter circuit of FIG. 9; and

FIG. 15 is a circuit diagram showing exemplary counter circuit.

### DESCRIPTION OF THE PREFERRED EMBODIMENT

Electroactive Generator

Piezoelectric and electrostrictive materials (generally called “electroactive” devices herein) develop an electric field when placed under stress or strain. The electric field developed by a piezoelectric or electrostrictive material is a function of the applied force and displacement causing the mechanical stress or strain. Conversely, electroactive devices undergo dimensional changes in an applied electric field. The dimensional change (i.e., expansion or contraction) of an electroactive element is a function of the applied electric field. Electroactive devices are commonly used as drivers, or “actuators” due to their propensity to deform under such electric fields. These electroactive devices when used as transducers or generators also have varying capacities to generate an electric field in response to a deformation caused by an applied force. In such cases they behave as electrical generators.

Electroactive devices include direct and indirect mode actuators, which typically make use of a change in the dimensions of the material to achieve a displacement, but in the present invention are preferably used as electromechanical generators. Direct mode actuators typically include a piezoelectric or electrostrictive ceramic plate (or stack of plates) sandwiched between a pair of electrodes formed on its major surfaces. The devices generally have a sufficiently large piezoelectric and/or electrostrictive coefficient to produce the desired strain in the ceramic plate. However, direct mode actuators suffer from the disadvantage of only being able to achieve a very small displacement (strain), which is, at best, only a few tenths of a percent. Conversely, direct mode generator-actuators require application of a high amount of force to piezoelectrically generate a pulsed momentary electrical signal of sufficient magnitude to activate a latching relay.

Indirect mode actuators are known to exhibit greater displacement and strain than is achievable with direct mode actuators by achieving strain amplification via external structures. An example of an indirect mode actuator is a flextensional transducer. Flextensional transducers are composite structures composed of a piezoelectric ceramic element and a metallic shell, stressed plastic, fiberglass, or similar structures. The actuator movement of conventional flextensional devices commonly occurs as a result of expansion in the piezoelectric material which mechanically couples to an amplified contraction of the device in the transverse direction. In operation, they can exhibit several orders of magnitude greater strain and displacement than can be produced by direct mode actuators.

The magnitude of achievable deflection (transverse bending) of indirect mode actuators can be increased by constructing them either as “unimorph” or “bimorph” flextensional actuators. A typical unimorph is a concave structure composed of a single piezoelectric element externally bonded to a flexible metal foil, and which results in axial buckling (deflection normal to the plane of the electroactive element) when electrically energized. Common unimorphs can exhibit transverse bending as high as 10%, i.e., a deflection normal to the plane of the element equal to 10% of the length of the actuator. A conventional bimorph device includes an intermediate flexible metal foil sandwiched between two piezoelectric elements. Electrodes are bonded to each of the major surfaces of the ceramic elements and the metal foil is bonded to the inner two electrodes. Bimorphs exhibit more displacement than comparable unimorphs because under the applied voltage, one ceramic element will contract while the other expands. Bimorphs can exhibit transverse bending of up to 20% of the Bimorph length.

For certain applications, asymmetrically stress biased electroactive devices have been proposed in order to increase the transverse bending of the electroactive generator, and therefore increase the electrical output in the electroactive material. In such devices, (which include, for example, “Rainbow” actuators (as disclosed in U.S. Pat. No. 5,471,721), and other flextensional actuators) the asymmetric stress biasing produces a curved structure, typically having two major surfaces, one of which is concave and the other which is convex.

Thus, various constructions of flextensional piezoelectric and ferroelectric generators may be used including: indirect mode actuators (such as “moonies” and, CYMBAL); bending actuators (such as unimorph, bimorph, multimorph or monomorph devices); prestressed actuators (such as “THUNDER” and rainbow” actuators as disclosed in U.S. Pat. No. 5,471,721); and multilayer actuators such as stacked actuators; and polymer piezofilms such as PVDF. Many other electromechanical devices exist and are contemplated to function similarly to power a transceiver circuit in the invention.

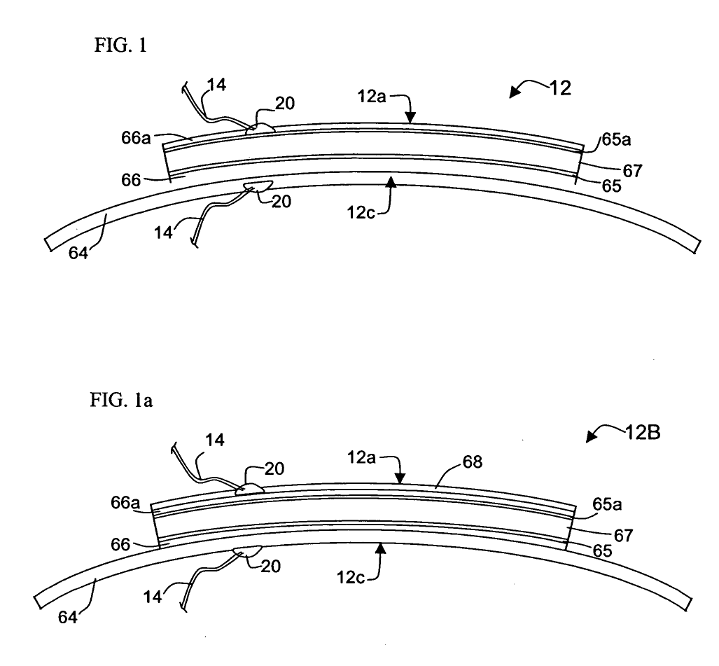

Referring to FIG. 1: The electroactive generator preferably comprises a prestressed unimorph device called “THUNDER”, which has improved displacement and load capabilities, as disclosed in U.S. Pat. No. 5,632,841. THUNDER (which is an acronym for THin layer composite UNimorph ferroelectric Driver and sEnsoR), is a unimorph device in which a pre-stress layer is bonded to a thin piezoelectric ceramic wafer at high temperature. During the cooling down of the composite structure, asymmetrical stress biases the ceramic wafer due to the difference in thermal contraction rates of the pre-stress layer and the ceramic layer. A THUNDER element comprises a piezoelectric ceramic layer bonded with an adhesive (preferably an imide) to a metal (preferably stainless steel) substrate. The substrate, ceramic and adhesive are heated until the adhesive melts and they are subsequently cooled. During cooling as the adhesive solidifies the adhesive and substrate thermally contracts more than the ceramic, which compressively stresses the ceramic. Using a single substrate, or two substrates with differing thermal and mechanical characteristics, the actuator assumes its normally arcuate shape. The transducer or electroactive generator may also be normally flat rather than arcuate, by applying equal amounts of prestress to each side of the piezoelectric element, as dictated by the thermal and mechanical characteristics of the substrates bonded to each face of the piezo-element.

The THUNDER element 12 is as a composite structure, the construction of which is illustrated in FIG. 1. Each THUNDER element 12 is constructed with an electroactive member preferably comprising a piezoelectric ceramic layer 67 of PZT which is electroplated 65 and 65a on its two opposing faces. A pre-stress layer 64, preferably comprising spring steel, stainless steel, beryllium alloy, aluminum or other flexible substrate (such as metal, fiberglass, carbon fiber, KEVLAR™, composites or plastic), is adhered to the electroplated 65 surface on one side of the ceramic layer 67 by a first adhesive layer 66. In the simplest embodiment, the adhesive layer 66 acts as a prestress layer. The first adhesive layer 66 is preferably LaRC™-SI material, as developed by NASA-Langley Research Center and disclosed in U.S. Pat. No. 5,639,850. A second adhesive layer 66a, also preferably comprising LaRC-SI material, is adhered to the opposite side of the ceramic layer 67. During manufacture of the THUNDER element 12 the ceramic layer 67, the adhesive layer(s) 66 and 66a and the pre-stress layer 64 are simultaneously heated to a temperature above the melting point of the adhesive material. In practice the various layers composing the THUNDER element (namely the ceramic layer 67, the adhesive layers 66 and 66a and the pre-stress layer 64) are typically placed inside of an autoclave, heated platen press or a convection oven as a composite structure, and slowly heated under pressure by convection until all the layers of the structure reach a temperature which is above the melting point of the adhesive 66 material but below the Curie temperature of the ceramic layer 67. Because the composite structure is typically convectively heated at a slow rate, all of the layers tend to be at approximately the same temperature. In any event, because an adhesive layer 66 is typically located between two other layers (i.e. between the ceramic layer 67 and the pre-stress layer 64), the ceramic layer 67 and the pre-stress layer 64 are usually very close to the same temperature and are at least as hot as the adhesive layers 66 and 66a during the heating step of the process. The THUNDER element 12 is then allowed to cool.

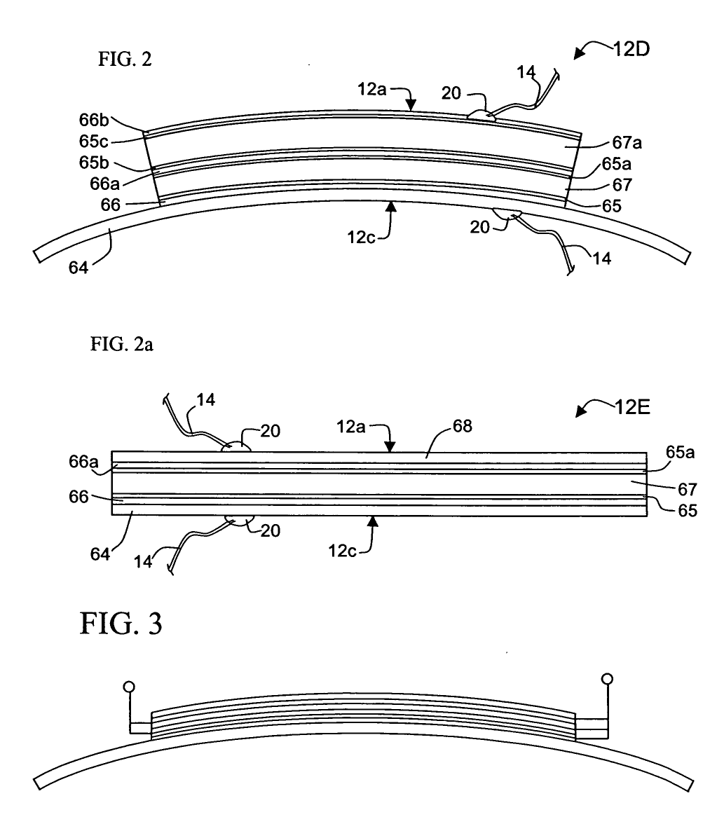

During the cooling step of the process (i.e. after the adhesive layers 66 and 66a have re-solidified) the ceramic layer 67 becomes compressively stressed by the adhesive layers 66 and 66a and pre-stress layer 64 due to the higher coefficient of thermal contraction of the materials of the adhesive layers 66 and 66a and the pre-stress layer 64 than for the material of the ceramic layer 67. Also, due to the greater thermal contraction of the laminate materials (e.g. the first pre-stress layer 64 and the first adhesive layer 66) on one side of the ceramic layer 67 relative to the thermal contraction of the laminate material(s) (e.g. the second adhesive layer 66a) on the other side of the ceramic layer 67, the ceramic layer deforms in an arcuate shape having a normally convex face 12a and a normally concave face 12c, as illustrated in FIGS. 1 and 2.

Referring to FIG. 1a: One or more additional pre-stressing layer(s) may be similarly adhered to either or both sides of the ceramic layer 67 in order, for example, to increase the stress in the ceramic layer 67 or to strengthen the THUNDER element 12B. In a preferred embodiment of the invention, a second prestress layer 68 is placed on the concave face 12a of the THUNDER element 12B having the second adhesive layer 66a and is similarly heated and cooled. Preferably the second prestress layer 68 comprises a layer of conductive metal. More preferably the second prestress layer 68 comprises a thin foil (relatively thinner than the first prestress layer 64) comprising aluminum or other conductive metal. During the cooling step of the process (i.e. after the adhesive layers 66 and 66a have re-solidified) the ceramic layer 67 similarly becomes compressively stressed by the adhesive layers 66 and 66a and pre-stress layers 64 and 68 due to the higher coefficient of thermal contraction of the materials of the adhesive layers 66 and 66a and the pre-stress layers 64 and 68 than for the material of the ceramic layer 67. Also, due to the greater thermal contraction of the laminate materials (e.g. the first pre-stress layer 64 and the first adhesive layer 66) on one side of the ceramic layer 67 relative to the thermal contraction of the laminate material(s) (e.g. the second adhesive layer 66a and the second prestress layer 68) on the other side of the ceramic layer 67, the ceramic layer 67 deforms into an arcuate shape having a normally convex face 12a and a normally concave face 12c, as illustrated in FIG. 1a.

Alternately, the second prestress layer 68 may comprise the same material as is used in the first prestress layer 64, or a material with substantially the same mechanical strain characteristics. Using two prestress layers 64, 68 having similar mechanical strain characteristics ensures that, upon cooling, the thermal contraction of the laminate materials (e.g. the first pre-stress layer 64 and the first adhesive layer 66,) on one side of the ceramic layer 67 is substantially equal to the thermal contraction of the laminate materials (e.g. the second adhesive layer 66a and the second prestress layer 68) on the other side of the ceramic layer 67, and the ceramic layer 67 and the transducer 12 remain substantially flat, but still under a compressive stress.

Alternatively, the substrate comprising a separate prestress layer 64 may be eliminated and the adhesive layers 66 and 66a alone or in conjunction may apply the prestress to the ceramic layer 67. Alternatively, only the prestress layer(s) 64 and 68 and the adhesive layer(s) 66 and 66a may be heated and bonded to a ceramic layer 67, while the ceramic layer 67 is at a lower temperature, in order to induce greater compressive stress into the ceramic layer 67 when cooling the transducer 12.

Referring now to FIG. 2: Yet another alternate THUNDER generator element 12D includes a composite piezoelectric ceramic layer 69 that comprises multiple thin layers 69a and 69b of PZT which are bonded to each other or cofired together. In the mechanically bonded embodiment of FIG. 2, two layers 69a and 69b, or more (not shown) my be used in this composite structure 12D. Each layer 69a and 69b comprises a thin layer of piezoelectric material, with a thickness preferably on the order of about 1 mil. Each thin layer 69a and 69b is electroplated 65 and 65a, and 65b and 65c on each major face respectively. The individual layers 69a and 69b are then bonded to each other with an adhesive layer 66b, using an adhesive such as LaRC-SI. Alternatively, and most preferably, the thin layers 69a and 69b may be bonded to each other by cofiring the thin sheets of piezoelectric material together. As few as two layers 69a and 69b, but preferably at least four thin sheets of piezoelectric material may be bonded/cofired together. The composite piezoelectric ceramic layer 69 may then be bonded to prestress layer(s) 64 with the adhesive layer(s) 66 and 66a, and heated and cooled as described above to make a modified THUNDER transducer 12D. By having multiple thinner layers 69a and 69b of piezoelectric material in a modified transducer 12D, the composite ceramic layer generates a lower voltage and higher current as compared to the high voltage and low current generated by a THUNDER transducer 12 having only a single thicker ceramic layer 67. Additionally, a second prestress layer may be used comprise the same material as is used in the first prestress layer 64, or a material with substantially the same mechanical strain characteristics as described above, so that the composite piezoelectric ceramic layer 69 and the transducer 12D remain substantially flat, but still under a compressive stress.

Referring now to FIG. 2b: Yet another alternate THUNDER generator element 12E includes another composite piezoelectric ceramic layer 169 that comprises multiple thin layers 169a-f of PZT which are cofired together. In the cofired embodiment of FIG. 2b, two or more layers 169a-f, and preferably at least four layers, are used in this composite structure 12E. Each layer 169a-f comprises a thin layer of piezoelectric material, with a thickness preferably on the order of about 1 mil, which are manufactured using thin tape casting for example. Each thin layer 169a-f placed adjacent each other with electrode material between each successive layer. The electrode material may include metallizations, screen printed, electro-deposited, sputtered, and/or vapor deposited conductive materials. The individual layers 169a-f and internal electrodes are then bonded to each other by cofiring the composite multi-layer ceramic element 169. The individual layers 169a-f are then poled in alternating directions in the thickness direction. This is accomplished by connecting high voltage electrical connections to the electrodes, wherein positive connections are connected to alternate electrodes, and ground connections are connected to the remaining internal electrodes. This provides an alternating up-down polarization of the layers 169a-f in the thickness direction. This allows all the individual ceramic layers 169a-f to be connected in parallel. The composite piezoelectric ceramic layer 169 may then be bonded to prestress layer(s) 64 with the adhesive layer(s) 66 and 66a, and heated and cooled as described above to make a modified THUNDER transducer 12D.

Referring again to FIGS. 2, 2a and 2b: By having multiple thinner layers 69a and 69b (or 169a-f) of piezoelectric material in a modified transducer 12D-F, the composite ceramic layer generates a lower voltage and higher current as compared to the high voltage and low current generated by a THUNDER transducer 12 having only a single thicker ceramic layer 67. This is because with multiple thin paralleled layers the output capacitance is increased, which decreases the output impedance, which pr9ovides better impedance matching with the electronic circuitry connected to the THUNDER element. Also, since the individual layers of the composite element are th8inner, the output voltage can be reduced to reach a voltage which is closer to the operating voltage of the electronic circuitry (in a range of 3.3V-10.0V) which provides less waste in the regulation of the voltage and better matching to the desired operating voltages of the circuit. Thus the multilayer element (bonded or cofired) improves impedance matching with the connected electronic circuitry and improves the efficiency of the mechanical to electrical conversion of the element.

A flexible insulator may be used to coat the convex face 12a of the transducer 12. This insulative coating helps prevent unintentional discharge of the piezoelectric element through inadvertent contact with another conductor, liquid or human contact. The coating also makes the ceramic element more durable and resistant to cracking or damage from impact. Since LaRC-SI is a dielectric, the adhesive layer 67a on the convex face 12a of the transducer 12 may act as the insulative layer. Alternately, the insulative layer may comprise a plastic, TEFLON or other durable coating.

Electrical energy may be recovered from or introduced to the generator element 12 (or 12D) by a pair of electrical wires 14. Each electrical wire 14 is attached at one end to opposite sides of the generator element 12. The wires 14 may be connected directly to the electroplated 65 and 65a faces of the ceramic layer 67, or they may alternatively be connected to the pre-stress layer(s) 64 and or 68. The wires 14 are connected using, for example, conductive adhesive, or solder 20, but most preferably a conductive tape, such as a copper foil tape adhesively placed on the faces of he electroactive generator element, thus avoiding the soldering or gluing of the conductor. As discussed above, the pre-stress layer 64 is preferably adhered to the ceramic layer 67 by LaRC-SI material, which is a dielectric. When the wires 14 are connected to the pre-stress layer(s) 64 and/or 68, it is desirable to roughen a face of the pre-stress layer 68, so that the pre-stress layer 68 intermittently penetrates the respective adhesive layers 66 and 66a, and makes electrical contact with the respective electroplated 65 and 65a faces of the ceramic layer 67. Alternatively, the Larc-SI adhesive layer 66 may have a conductive material, such as Nickel or aluminum particles, used as a filler in the adhesive and to maintain electrical contact between the prestress layer and the electroplated faces of the ceramic layer(s). The opposite end of each electrical wire 14 is preferably connected to an electric pulse modification circuit 10.

Prestressed flextensional transducers 12 are desirable due to their durability and their relatively large displacement, and concomitant relatively high voltage that such transducers are capable of developing when deflected by an external force. The present invention however may be practiced with any electroactive element having the properties and characteristics herein described, i.e., the ability to generate a voltage in response to a deformation of the device. For example, the invention may be practiced using magnetostrictive or ferroelectric devices. The transducers also need not be normally arcuate, but may also include transducers that are normally flat, and may further include stacked piezoelectric elements.

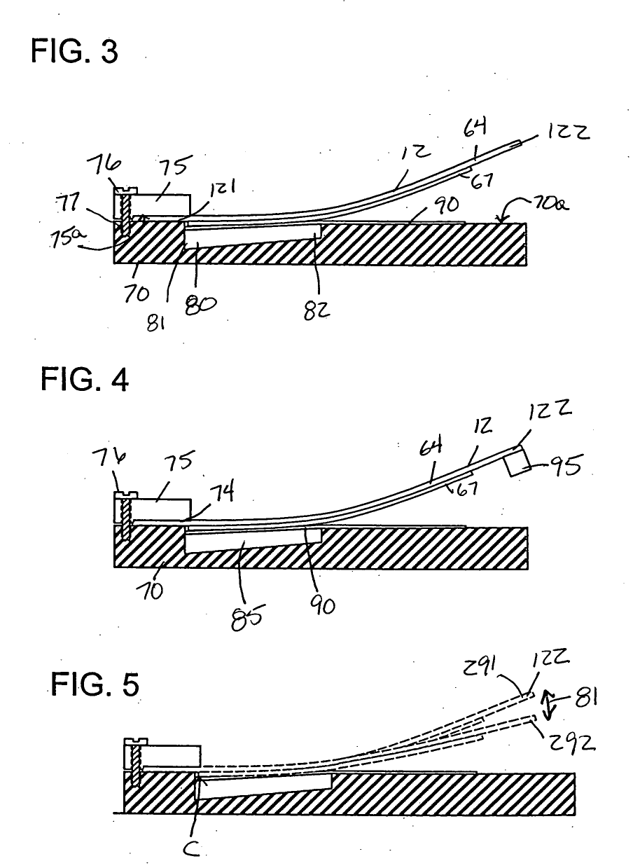

As shown in FIGS. 3-5, when the actuator 12 is deflected by a force as indicated by arrow 16, the piezoelectric element 67 bonded thereto deforms. The force causing the deflection may be transmitted to the piezoelectric actuator 12 by any appropriate means, but most preferably is mechanically transmitted to the actuator 12 directly from the piece of vibrating equipment to which it is attached. The actuator 12 is attached by mounting one or more ends 121 and 122 of the actuator 12 to the vibrating piece of equipment. Preferably, the mechanical force is in the form of vibrational energy which is transmitted from the machinery to the actuator 12, which sets the actuator 12 into vibration at substantially the same frequency as the machinery vibration and proportional to the amplitude of those vibrations. The vibrational energy transmitted to the actuator 12 is sufficient to cause the actuator 12 to deform quickly, accelerating over a short distance (approximately from 0.01-10.0 mm) which generates an electrical signal.

Referring again to FIGS. 3-5.: In the preferred embodiment of the invention, the actuator 12 is clamped at one end 121 and the mechanical impulse is transmitted to the actuator 12 setting the edge of the free end 122 in motion, i.e., at the end opposite to the clamped end 121 of the actuator 12. By setting the free end 122 of the actuator 12 in vibration, an electrical signal is generated that is an oscillating wave. Larger or multiple electroactive actuator elements may also be used to generate the electrical signal.

FIG. 3 illustrates one embodiment of a device for generating an electrical signal by transmission of vibration to an actuator 12. This device comprises an actuator 12 mounted between a base plate 70 and a clamping member 75. The base plate 70 is preferably of substantially the same shape (in plan view) as the actuator 12 attached thereon, and most preferably rectangular. One end 121 of the piezoelectric actuator 12 is held in place between the clamping member 75 and the upper surface 70a of a base plate 70, preferably on one end thereof. The clamping member 75 comprises a plate or block having a lower surface 75a designed to mate with the upper surface 70a of the base plate 70, with an end 121 of the actuator 12 therebetween. The device also has means for urging 76 the mating surface 75a of the clamping block towards the upper surface 70a of the base plate 70. This allows the lower surface 75a of the clamping plate 75 to be substantially rigidly coupled to the upper surface 70a of the base plate 70, preferably towards one side of the base plate 70. The means for urging 76 together the mating surfaces 70a and 75a of the base plate 70 and clamping plate 75 may comprise screws, clamping jaws or springs or the like. Most preferably the urging means 76 comprises at least one screw 76 passing through the clamping member 75 and into a screw hole 77 in the upper surface 70a of the base plate 70.

One end 121 of an actuator 12 is placed between the mating surfaces 70a and 75a of the base and clamping plates 70 and 75. The mating surfaces 70a and 75a are then urged towards each other with the screw 76 to rigidly hold the end 121 of the actuator 12 in place between the base and clamping plates 70 and 75 with the opposite end 122 of the actuator 12 free to move in response to vibrations transmitted thereto from the attached piece of equipment.

In the preferred embodiment of the invention the surfaces 70a and 75a of the base and clamping plate 70 and 75 are designed to best distribute pressure evenly along the end 121 of the actuator therebetween. To this end the upper surface 70a of the base plate 70 contacting the end 121 of the actuator is preferably substantially flat and lower surface 75a of the clamping member 75 preferably has a recess 74 therein which accommodates insertion of the actuator end 121 therein. Preferably the depth of the recess 74 is equal to half the thickness of the actuator substrate 64, but may be as deep as the substrate 31 thickness. Thus, the end 121 of the actuator 12 may be placed between the recess 74 and the upper surface 70a of the base plate 70 and secured therebetween by the screw 76. Alternatively, either or both of the mating surfaces 70a and 75a of the base and clamping plates 70 and 75 may have a recess therein to accommodate insertion and retention of the end 121 of the actuator 12 therebetween. The portion of the bottom surface 75a of the clamping member 75 beyond the recess 74 has no contact with the actuator 12, and is that portion through which the screw 76 passes. This portion of the bottom surface 75a may contact the upper surface 70a of the base plate 70, but most preferably there is a small gap (equal to the difference of the substrate thickness and the recess depth) between the lower surface 75a of the clamping member 75 and the top surface 70a of the base plate 70 when the actuator 12 is inserted therebetween. In yet another embodiment of the invention, the mating surfaces 70a and 75a of the base and clamping plates 70 and 75 may be adhesively bonded together (rather than screwed) with the end 121 of the actuator 12 sandwiched therebetween. In yet another alternative embodiment of the device, the clamping member 75 and base plate 70 may comprise a single molded structure having a central slot into which may be inserted one end 121 of the actuator 12.

The clamping assembly 75 holds the actuator 12 in place in its relaxed, i.e., undeformed state above the base plate 70 with the free end 122 of the actuator 12 a distance from the base plate 70. More specifically, the actuator 12 is preferably clamped between the mating surfaces 70a and 75a of the base and clamping plates 70 and 75 with the convex face 12a of the actuator 12 facing the base plate 70. Since the actuator 12 in its relaxed state is arcuate, the convex face 12a of the actuator 12 curves away from the upper surface 70a of the base plate 70 while approaching the free end 122 of the actuator 12. Therefore the free end 122 of the actuator 12 is free to vibrate without interference from the base plate and thereby deforming the electroactive element 67 to develop an electrical signal.

Because of the composite, multi-layer construction of the actuator 12 it is important to ensure that the clamping member 75 not only holds the actuator 12 rigidly in place, but also that the actuator 12 is not damaged by the clamping member 75. In other words, the actuator 12, and more specifically the ceramic layer 67, should not be damaged by the clamping action of the clamping member 75 in a static mode, but especially in the dynamic state when the actuator 12 vibrates. For example, referring to FIG. 5, when the actuator 12 is deflected in the direction of arrow 81, the bottom corner of the ceramic (at point C) contacts the base plate 70 and is further pushed into the base plate, which may crack or otherwise damage the ceramic layer 67.

Referring again to FIGS. 3-5: It has been found that the tolerances between the mating surfaces 75a and 70a of the clamping and base plates 75 and 70 are very narrow. It has also been found that at the extremities of the actuator's 12 motion, the deflection of the free end 122 of the actuator 12 would cause the ceramic element 67 of the actuator 12 to contact the upper surface 70a of the base plate 70, thereby making more likely damage to the ceramic 67. Therefore, in the preferred embodiment of the invention, the switch plate 70 has a recessed area 80 in its upper surface 70a which not only protects the electroactive element 67 from damage but also provides electrical contact to the convex face 12a of the actuator 12 so that the electrical signal developed by the actuator 12 may be applied to downstream circuit elements.

As can be seen in FIGS. 3-5, one end 121 of the actuator is placed between the surfaces 75a and 70a of the clamping and base plates 75 and 70 such that only the substrate 64 contacts both surface 75a and 70a. The clamping plate 75 preferably contacts the concave surface 12b of the actuator 12 along the substrate 64 up to approximately the edge of the ceramic layer 67 on the opposite face 12a of the actuator 12. The clamping member may however extend along the convex face 12c further than the edge C of the ceramic layer 67 in order to apply greater or more even pressure to the actuator surfaces 12a and 12c between the clamping member 75 and base plate 70. The ceramic layer 67 which extends above the surface of the substrate 64 on the convex face 12a extends into the recessed area 80 of the switch plate 70. This prevents the ceramic layer 67 from contacting the upper surface 70a of the base plate 70, thereby reducing potential for damage to the ceramic layer 67.

The recess 80 is designed not only to prevent damage to the ceramic layer 67, but also to provide a surface along which electrical contact can be maintained with the electrode 68 on the convex face of the actuator 12. The recess 80 extends into the base plate 70 and has a variable depth, preferably being angled to accommodate the angle at which the convex face 12a of the actuator 12 rises from the recess 80 and above the top surface 70a of the base plate 70. More specifically, the recess 80 preferably has a deep end 81 and a shallow end 82 with its maximum depth at the deep end 81 beneath the clamping member 75 and substrate 64 just before where the ceramic layer 67 extends into the recess 80 at point C. The recess 80 then becomes shallower in the direction approaching the free end 122 of the actuator 12 until it reaches its minimum depth at the shallow end 82.

The recess 80 preferably contains a layer of rubber 85 along its lower surface which helps prevent the ceramic layer 67 from being damaged when the actuator 12 is deformed and the lower edge C of the ceramic layer 67 is pushed into the recess 80. Preferably the rubber layer 85 is of substantially uniform thickness along its length, the thickness of the rubber layer 85 being substantially equal to the depth of the recess 80 at the shallow end 82. The length of the rubber layer 85 is preferably slightly shorter than the length of the recess 80 to accommodate the deformation of the rubber layer 85 when the actuator 12 is pushed into the recess and rubber layer 85.

The rubber layer 85 preferably has a flexible electrode layer 90 overlying it to facilitate electrical contact with the aluminum layer 68 on the ceramic layer 67 on the convex face 12a of the actuator 12. More preferably, the electrode layer 90 comprises a layer of copper overlaying a layer of KAPTON film, as manufactured by E.I. du Pont de Nemours and Company, bonded to the rubber layer 85 with a layer of adhesive, preferably CIBA adhesive. The electrode layer 90 preferably extends completely across the rubber layer 85 from the deep end 81 to the shallow end 82 of the recess 80 and continues for a short distance on the top surface 70a of the base plate 70 beyond the recess 80.

In the preferred embodiment of the invention, the end 121 of the actuator 12 is not only secured between the clamping plate 75 and the base plate 70, but the aluminum electrode layer 68 covering the ceramic layer 67 of the actuator 12 is in direct contact with the electrode layer 90 in the recess 80 at all times, regardless of the position of the actuator 12 in its complete range of motion. To this end, the depth of the recess 80 (from the top surface 70a to the electrode 90) is at least equal to a preferably slightly less than the thickness of the laminate layers (adhesive layers 66, ceramic layer 67 and prestress layer 68) extending into the recess 80.

An assembly was built having the following illustrative dimensions. The actuator comprised a 1.59 by 1.79 inch spring steel substrate that was 8 mils thick. A 1-1.5 mil thick layer of adhesive having a nickel dust filler in a 1.51 inch square was placed one end of the substrate 0.02 inch from three sides of the substrate (leaving a 0.25 inch tab on one end 121 of the actuator). An 8-mil thick layer of PZT-5A in a 1.5 inch square was centered on the adhesive layer. A 1-mil thick layer of adhesive (with no metal filler) was placed in a 1.47 inch square centered on the PZT layer. Finally, a 1-mil thick layer of aluminum in a 1.46 inch square was centered on the adhesive layer. The tab 121 of the actuator was placed in a recess in a clamping block 76 having a length of 0.375 inch and a depth of 4 mils. The base plate 70 had a 0.26 in long recess 80 where the deep end 81 of the recess had a depth of 20 mils and tapered evenly to a depth of 15 mils at the shallow end 82 of the recess 80. A rubber layer 85 having a thickness of 15 mils and a length of 0.24 inches was placed in the recess 80. An electrode layer of 1 mil copper foil overlying 1 mil KAPTON tape was adhered to the rubber layer and extended beyond the recess 1.115 inches. The clamping member 75 was secured to the base plate 70 with a screw 76 and the aluminum second prestress layer of the actuator 12 contacted the electrode 90 in the recess 80 substantially tangentially (nearly parallel) to the angle the actuator 12 thereby maximizing the surface area of the electrical contact between the two.

As shown in FIG. 4, in another embodiment of the invention, a weight 95 may be attached to the free end 122 of the actuator 12. The addition of the mass 95 to the free end 122 of the actuator 12, increases the amplitude and duration of oscillation of the actuator 12. By having a longer duration and higher overall amplitude oscillation, the actuator 12 is capable of developing more electrical energy from its oscillation than an actuator 12 having no additional mass at its free end 122.

As shown in FIG. 5, the vibrational energy causes the piezoelectric actuator 12 to vibrationally deform. The actuator 12 is constructed with the substrate and/or prestress layers 64 and 68 exerting a compressive force on the ceramic 67 bonded thereto, thereby providing a restoring force. Therefore, the actuator 12 has a coefficient of elasticity or spring constant that causes the actuator 12 to tend to return to its undeformed neutral state when deflected. Thus, as the actuator 12 is vibrated by the attached machinery, the free edge 122 of the actuator 12 tends to be deflected and to spring back toward its undeformed state, thereby oscillating about its undeformed position between positions 291 and 292. The oscillation of the actuator 12 has a substantially sinusoidal waveform, i.e., harmonic oscillation.

As the actuator 12 oscillates, the ceramic layer 67 strains, becoming alternately more compressed and less compressed. By virtue of the piezoelectric effect, deformation of the piezoelectric element 67 generates an instantaneous voltage between the faces 12a and 12c of the actuator 12, which produces pulses of electrical energy. The polarity of the voltage produced by the ceramic layer 67 depends on the direction of the strain, and therefore, the polarity of the voltage generated in compression is opposite to the polarity of the voltage generated in tension. Thus, when deforming in one direction, e.g., to position 291, the actuator 12 generates a voltage of a first polarity. When deforming in the opposite direction, e.g., to position 292, the actuator 12 generates a voltage of opposite polarity. Thus, as the actuator 12 vibrates between positions 291 and 292, it is capable of generating an oscillating signal having alternating polarity.

Since the equipment applies a vibrational impulse directly to the electroactive actuator 12 and electroactive element 67, the element 67 generates an oscillating electrical signal at substantially the same frequency as the machinery vibration and proportional to the amplitude of those vibrations. This signal is not only indicative of the state of the equipment's vibration, but also has sufficient magnitude to actuate downstream circuit components. The accompanying circuitry designed to work with an oscillating electrical signal to harness the power generated by the electroactive element 67, and the accompanying RF signal generation circuitry is configured to use the oscillating electrical signal most efficiently.

The electrical signal generated by the actuator 12 is applied to downstream circuit elements via wires 14 connected to the actuator 12. More specifically, a first wire 14 is connected to the electrode 90 which extends into the recess 80 and contacts the electrode 68 on the convex face 12a of the actuator 12. Preferably the wire 14 is connected to the electrode 90 outside of the recess close to the end of the base plate 70 opposite the end having the clamping member 75. A second wire 14 is connected directly to the first prestress layer 64, i.e., the substrate 64 which acts as an electrode on the concave face 12c of the actuator 12.

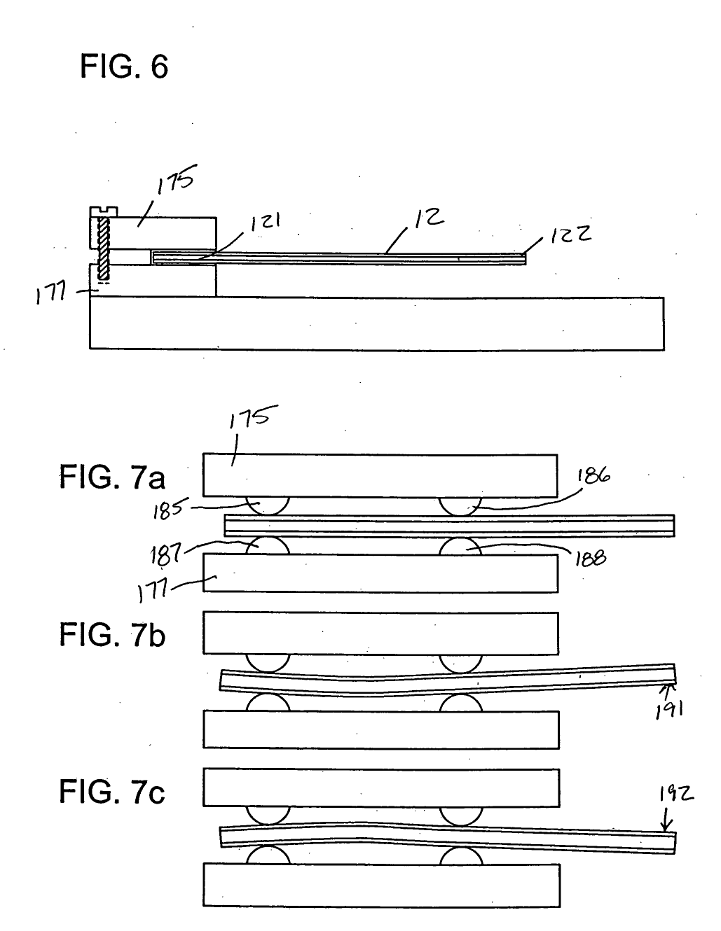

Referring now to FIG. 6 and FIGS. 7 1a-c: In an alternative embodiment of a vibration monitoring device includes mounting means for retaining a flat actuator as in FIG. 2a. An alternate means for clamping the transducer 12 is shown, wherein each of the clamping plates 175, 177 has rounded projections thereon, for retaining the transducer 12, yet allowing some bending or the transducer 12 between the plates 175, 177, in order to distribute and reduce point bending forces on the retained portion 121 of the transducer 12. The clamping plates 175, 177 are urged together, preferably using one or more screws or bolts (not shown). In the preferred embodiment of the clamping plates 175, 177, the upper clamping plate 175 has two rounded projections 185, 186 thereon and the lower clamping plate 177 also has two rounded projections 187, 188 thereon. Each projection 185-188 is preferably shaped substantially like a half cylinder with the radius of the cylinder extending from the mating faces of the clamping plates 175, 177, and in the height dimension of the half cylinder are substantially perpendicular to the direction along which the transducer 12 extends from the plates 175, 177. The projections are constructed of a rigid, durable material such as metal or hard plastic. Each of the projections 185, 186 and 187, 188 are parallel to each other and equidistant, i.e., projections 185 and 186 are parallel and separated by the same distance as parallel projection 187 and 188. This facilitates placing the end 121 of the transducer 12 between the projections 185-188 so that the end 121 is retained between the plates 175, 177 along two parallel lines corresponding to the projections 185, 187 and 186, 188 on either side of the respective lines. The projections may alternately comprise multiple hemispherical projections, wherein each projection 185-188 comprises two or more hemispherical projections situated along the same axis as the semi-cylindrical projections 185-188.

As can be seen in FIGS. 7a-7c, when the free end 122 of transducer 12 is deflected as shown by arrows 191 and 192, the end 121 of the transducer 12 between the projections 185-188 is allowed to bend between and around the projections 185-188. Furthermore, the rounded shape of the projections 185-188 reduces point bending stresses in the transducer 12. This is because as the transducer 12 bends, the lines along which the projections 185, 187 and 186, 188 retain the transducer 12 actually shift slightly off of center (i.e., the apex of the projection) so that the transducer 12 is contacted at different points depending upon the amount the transducer 12 is deflected. This configuration allows the retained end 121 of the transducer 12 to bend without point stresses by distributing the stresses, thereby increasing the durability of the transducer 12, and also providing less attenuation to the desired oscillation of the transducer 12 due to the clamping.

Frequency Monitor and RF Transmission Circuit

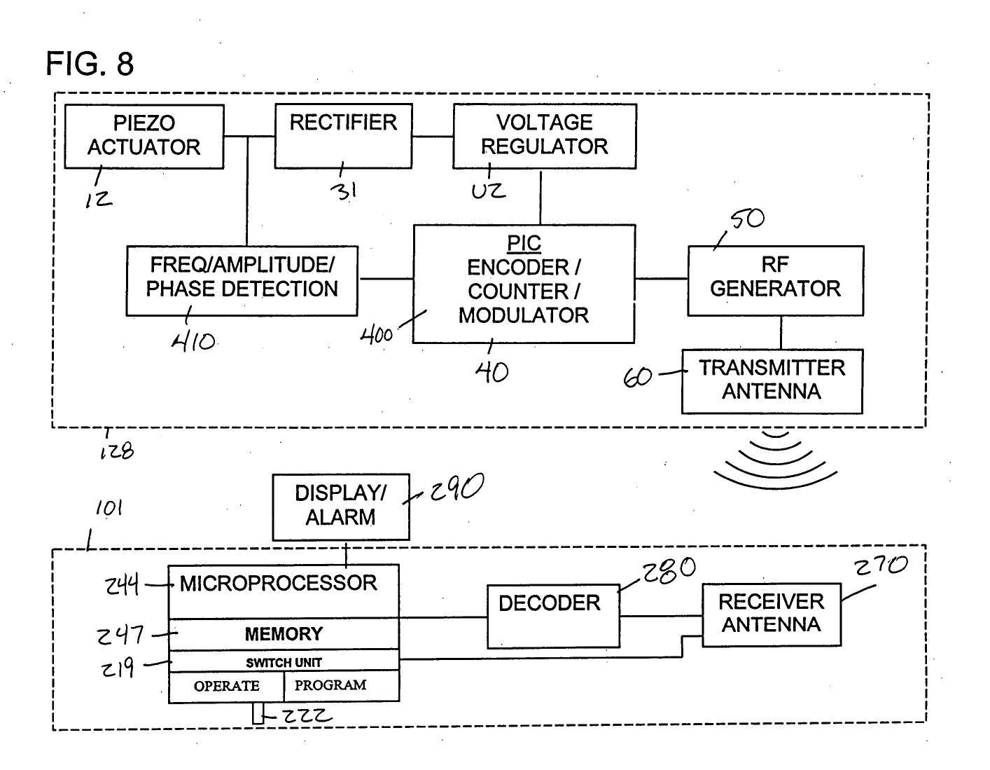

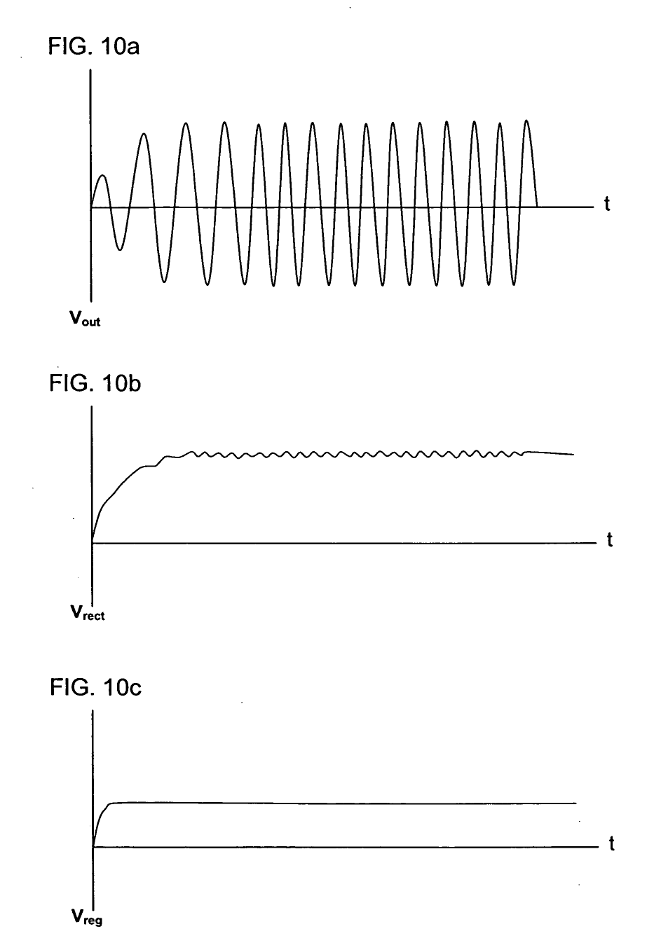

Referring to FIG. 8, the actuator 12 is connected to circuit components downstream including sensing elements for the frequency, amplitude, phase and/or current as well as transmitter elements for generating an RF signal for transmission of the equipment's vibrational state to a receiver for further processing. The circuit components for the transmitter include a rectifier 31, a voltage regulator U2, an encoder 40 (preferably comprising a peripheral interface controller (PIC) chip), as well as an RF generator 50 and antenna 60. FIG. 10a shows the waveform of the electrical signal sensed by the sensing elements of the circuit. FIG. 10b shows the waveform of the electrical signal of FIG. 10a after it has been rectified. FIG. 10c shows the waveform of the rectified electrical signal of FIG. 10b after it has been regulated to a substantially uniform voltage, preferably 3.3 VDC for use by the PIC.

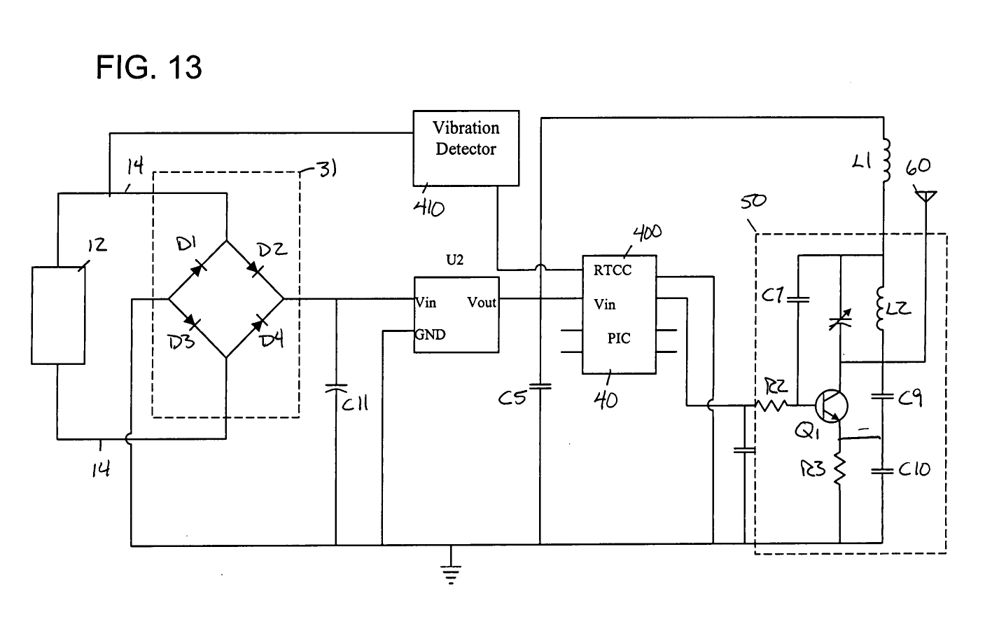

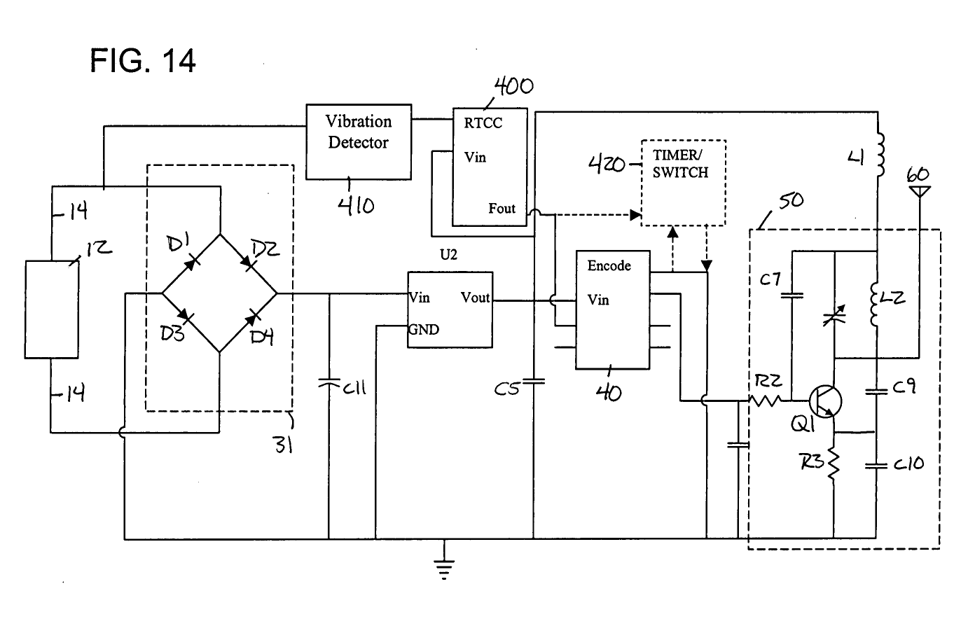

Referring now to FIGS. 8-9 and 13: The actuator 12 is connected to a rectifier 31 in order to provide substantially constant regulated voltage to the transmitter portion of the circuit. Preferably the rectifier 31 comprises a bridge rectifier 31 comprising four diodes D1, D2, D3 and D4 arranged to only allow positive voltages to pass. The first two diodes D1 and D2 are connected in series, i.e., the anode of D1 connected to the cathode of D2. The second two diodes D3 and D4 are connected in series, i.e., the anode of D3 connected to the cathode of D4. The anodes of diodes D2 and D4 are connected, and the cathodes of diodes D1 and D3 are connected, thereby forming a bridge rectifier. The rectifier is positively biased toward the D2-D4 junction and negatively biased toward the D1-D3 junction. One of the wires 14 of the actuator 12 is electrically connected between the junction of diodes D1 and D2, whereas the other wire 14 (connected to the opposite face of the actuator 12) is connected to the junction of diodes D3 and D4. The junction of diodes D1 and D3 are connected to ground. A capacitor C11 is preferably connected on one side to the D2-D4 junction and on the other side of the capacitor C11 to the D1-D3 junction in order to isolate the voltages at each side of the rectifier from each other. Therefore, any negative voltages applied to the D1-D2 junction or the D3-D4 junction will pass through diodes D1 or D3 respectively to ground. Positive voltages applied to the D1-D2 junction or the D3-D4 junction will pass through diodes D2 or D4 respectively to the D2-D4 junction. The rectified waveform is shown in FIG. 10b.

The circuit also comprises a voltage regulator U2, which controls magnitude of the input electrical signal downstream of the rectifier 31. The rectifier 31 is electrically connected to a voltage regulator U2 with the D2-D4 junction connected to the Vin pin of the voltage regulator U2 and with the D1-D3 junction connected to ground and the ground pin of the voltage regulator U2. The voltage regulator U2 comprises for example a LT1121 chip voltage regulator U2 with a 3.3 volts DC output. The output voltage waveform is shown in FIG. 10c and comprises a substantially uniform voltage signal of 3.3 volts that continues as long as the actuator 12 is vibrating. The regulated waveform is shown in FIG. 10b. The output voltage signal from the voltage regulator (at the Vout pin) may then be transmitted via another conductor through an encoder 40 to an RF generation section 50 of the circuit.

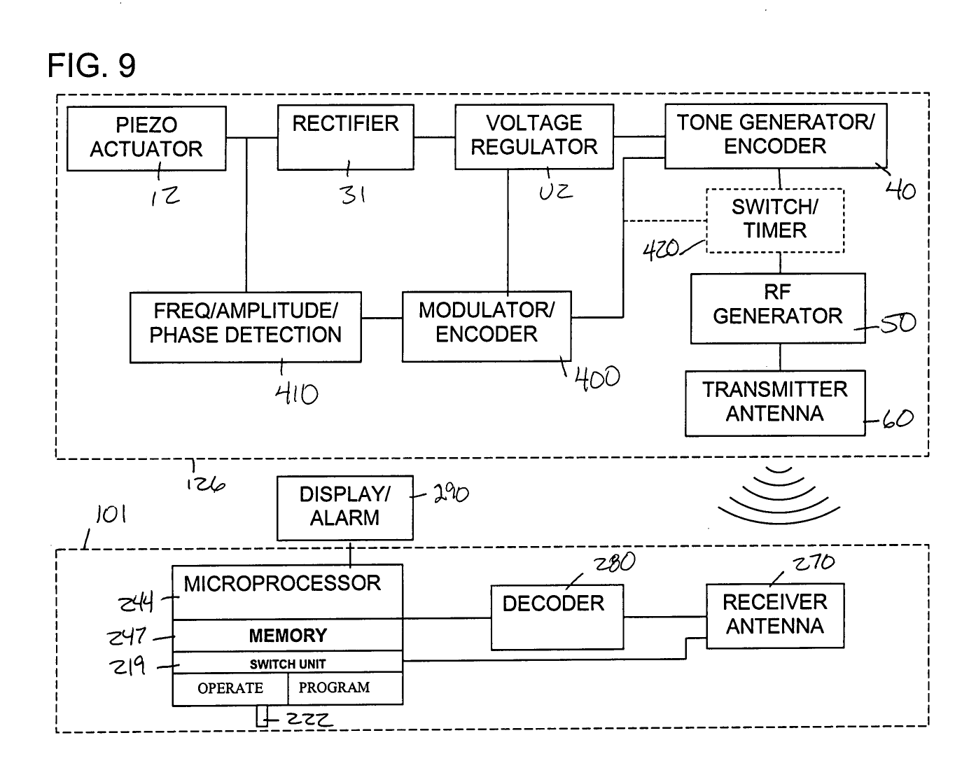

Referring again to FIGS. 8 and 9: The output of the voltage regulator U2 is preferably used to power a frequency counter 400 and an encoder 40 or tone generator, which comprise one or more programmable interface controllers (PIC) microcontroller that generates a pulsed tone or code. This pulsed tone modulates an RF generator section 50 which radiates an RF signal using a tuned loop antenna 60. The signal radiated by the loop antenna is intercepted by an RF receiver 270 and a decoder 280 which generates a signal input to the display or alarm device 290.

Types of register-based PIC microcontrollers include the eight-pin PIC12C5XX and PIC12C67x, baseline PIC16C5X, midrange PIC16CXX and the high-end PIC17CXX/PIC18CXX. These controllers employ a modified Harvard, RISC architecture that support various-width instruction words. The datapaths are 8 bits wide, and the instruction widths are 12 bits wide for the PIC16C5X/PIC12C5XX, 14 bits wide for the PIC12C67X/PIC16CXX, and 16 bits wide for the PIC17CXX/PIC18CXX. PICMICROS are available with one-time programmable EPROM, flash and mask ROM. The PIC17CXX/PIC18CXX support external memory. The encoder 40 comprises for example a PIC model 12C671. The PIC12C6XX products feature a 14-bit instruction set, small package footprints, low operating voltage of 2.5 volts, interrupts handling, internal oscillator, on-board EEPROM data memory and a deeper stack. The PIC12C671 is a CMOS microcontroller programmable with 35 single word instructions and contains 1024×14 words of program memory, and 128 bytes of user RAM with 10 MHz maximum speed. The PIC12C671 features an 8-level deep hardware stack, 2 digital timers (8-bit TMR0 and a Watchdog timer), and a four-channel, 8-bit A/D converter.

The output of the voltage regulator U2 is connected to a PIC microcontroller, which acts as an encoder 40 for the electrical output signal of the regulator U2. More specifically, the output conductor for the output voltage signal (nominally 3.3 volts) is connected to the input pin of the programmable encoder 40. The output of the PIC may include square, sine or saw waves or any of a variety of other programmable waveforms. Typically, the output of the encoder 40 is a series of binary square waveforms (pulses) oscillating between 0 and a positive voltage, preferably +3.3 VDC. The duration of each pulse (pulse width) is determined by the programming of the encoder 40 and the duration of the complete waveform is determined by the duration of output voltage of the voltage regulator U2. A capacitor C5 is preferably be connected on one end to the output of the voltage regulator U2, and on the other end to ground to act as a filter between the voltage regulator U2 and the encoder 40.

Thus, the use of a PIC as a tone generator or encoder 40 allows the encoder 40 to be programmed with a variety of values. The encoder 40 is capable of generating one of many unique encoded signals by simply varying the programming for the output of the encoder 40. More specifically, the encoder 40 can generate one of a billion or more possible codes. It is also possible and desirable to have more than one encoder 40 included in the circuit in order to generate more than one code from one actuator or transmitter. Alternately, any combination of multiple actuators and multiple pulse modification subcircuits may be used together to generate a variety of unique encoded signals. Alternately the encoder 40 may comprise one or more inverters forming a series circuit with a resistor and capacitor, the output of which is a square wave having a frequency determined by the RC constant of the encoder 40.

The DC output of the voltage regulator U2 and the coded output of the encoder 40 are connected to an RF generator 50. A capacitor C6 may preferably be connected on one end to the output of the encoder 40, and on the other end to ground to act as a filter between the encoder 40 and the RF generator 50. The RF generator 50 consists of tank circuit connected to the encoder 40 and voltage regulator U2 through both a bipolar junction transistor (BJT) Q1 and an RF choke. More specifically, the tank circuit consists of a resonant circuit comprising an inductor L2 and a capacitor C8 connected to each other at each of their respective ends (in parallel). Either the capacitor C8 or the inductor L2 or both may be tunable in order to adjust the frequency of the tank circuit. An inductor L1 acts as an RF choke, with one end of the inductor L1 connected to the output of the voltage regulator U2 and the opposite end of the inductor L1 connected to a first junction of the L2-C8 tank circuit. Preferably, the RF choke inductor L1 is an inductor with a diameter of approximately 0.125 inches and tums on the order of thirty and is connected on a loop of the tank circuit inductor L2. The second and opposite junction of the L2-C8 tank circuit is connected to the collector of BJT Q1. The base of the BJT Q1 is also connected through resistor R2 to the output side of the encoder 40. A capacitor C7 is connected to the base of a BJT Q1 and to the first junction of the tank circuit. Another capacitor C9 is connected in parallel with the collector and emitter of the BJT Q1. This capacitor C9 improves the feedback characteristics of the tank circuit. The emitter of the BJT Q1 is connected through a resistor R3 to ground. The emitter of the BJT Q1 is also connected to ground through capacitor C10 which is in parallel with the resistor R3. The capacitor C10 in parallel with the resistor R4 provides a more stable conduction path from the emitter at high frequencies.

Referring again to FIG. 9: The actuator 12 is also connected to a vibration sensor 410 for sensing of frequency, amplitude and/or phase of the actuators vibration. In the preferred embodiment of the invention, frequency sensing is used. For the frequency sensor a BJT configured as a common emitter collector, and resistor may be used. The output of the frequency sensor is a series of on/off voltage pulses. These voltage pulses are input to a counter 400 which preferably comprises a PIC, which is programmed to count the number of pulses, and divide by a sampling time to calculate to frequency of the pulses. The counting/frequency calculation algorithm is preferably programmed into the same PIC 40 used as the encoder 40 (most preferably a 16C5XX series PIC). The use of a PIC instead of discrete logic offers enormous savings in circuit complexity, cost and assembly time.

The frequency counting circuit 410, 400 is built around a member of the PIC family of microcontrollers, e.g., the 16C54 from Arizona Microchip. Basing the circuit on a microcontroller, rather than opting for conventional electronic circuit, gives a greater degree of flexibility. Since software is more adaptable than hardware, it is much easier to change a line or two in the source code than to add another track to a PCB. The PIC is an excellent microcontroller for this type of project. It is robust, simple to interface with other components, and relatively simple to program (or at least no harder than any other microcontroller or microprocessor). With the PIC there are typically around 33 instructions. This counter can operate to over 46 MHz using a prescaler when driven from a GDO loosely coupled to the input amplifier via a 4 turn coil. However, it is preferred that the counter operate in a range of 10's of hertz to 100's of kilohertz.

The PIC 16C54 has thirteen input/output (I/O) pins of which twelve are general purpose. The remaining I/O pin is connected to an internal register in the PIC called the RTCC (real time clock/counter). This register can count either internal instructions or external pulses. In the present invention, it is desirable to use its ability to count pulses. The RTCC pin is connected to an external probe, i.e., vibration sensor 410 for the meter via some circuitry to condition the input signal. The RTCC can trigger on a rising or a falling edge, and is conventionally selected to trigger on rising edges. The electrical schematic is very simple, given that most of the functions are implemented by the microprocessor.

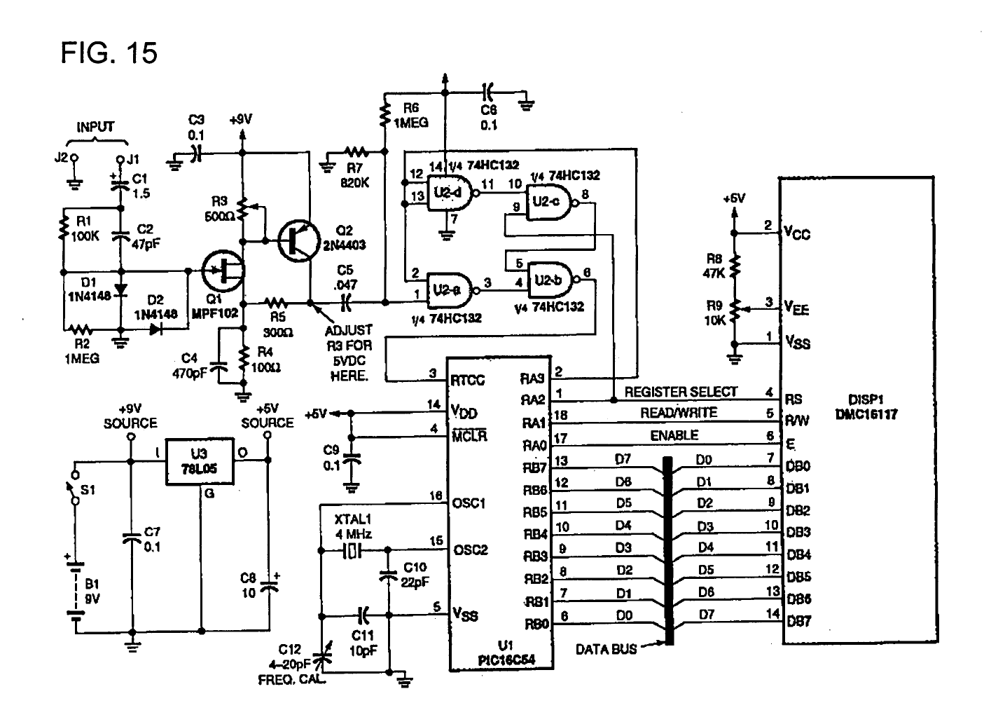

An exemplary counter circuit 400 for determining the frequency is shown in FIG. 15: An amplifier stage is used to raise the input signal level from 200-300 mV per pulse to about 3 volts per pulse, so as to drive correctly the RA4 (pin 3) triggered gate of the PIC 400. For amplification, a common emitter amplifier such as a 2N2369 transistor, with a small inductance series connected to the collector load, can be used to improve the frequency response at the high frequencies. So it was obtained a suitable gain from 100 KHz up to about 50 MHz, the lower limit being forced only by the C10 capacitor. The time base is provided from a 4 MHz, parallel resonant, microprocessor crystal. With a frequency meter, you may tune accurately the frequency by adjusting the value of C9, which could also be replaced by a little plastic trimmer. Otherwise the reading will be in any case within the quartz tolerance (typically 50 p.p.m. max).

The counter 400 works using the 8 bits internal counter (TMRO) and the 8 bits prescaler of the PIC. To improve the resolution a third 8 bits counter may be implemented by the program when a timer overflow is detected, so it is possible to improve the overall counters capacity to 24 bits. The counting period is set to 100 mS, obtained by means of some accurate delay routines, tuned precisely using workbench instrumentation.

There is also a prescaler associated with the RTCC which can prescale the input to the counter from 1:2 to 1:256. The desired accuracy of ±1 Hz rules out using an RC oscillator to drive the microcontroller. A crystal or ceramic resonator may be used to measure up to an 8 MHz input signal so the processor needs to be fast. Resonator versions of the chip run up to 4 MHz, crystal versions up to 20 MHz. Each PIC instruction takes 4 clock cycles to execute, so a 20 MHz PIC has a performance of 5 million instructions per second.

To measure the frequency of a signal the PIC 400 simply counts the total number of pulses over a fixed period of time, typically 1 second. This will always give a reading accurate to ±1 Hz. For high frequencies (above 10 kHz) the meter can be made more responsive by timing over a shorter period, say ⅛ s. This reduces the accuracy to ±8 Hz. Longer sampling times may also be used

The RTCC can't count more than one pulse per instruction cycle (per 4 clock cycles). With a 20 MHz crystal it can count a maximum of 5 million pulses per second. For higher signal frequencies a prescaler may be used. This has the effect of dividing down the input frequency to the counter.

In order to dispense with range switches or the equivalent the PIC software is adaptive to a range of input signal frequencies, from a few tens of Hz to MHz. To generate an output signal covering such a range of frequencies using four digits (i.e. without being able to display the units, whether Hz, kHz or MHz), the units of the signal frequency are chosen to be in kHz. The output signals are common cathode and are activated by pulling the common pin low and then writing 1's or 0's to the individual segments. If the common pin is high then no current can flow. In this way just one display can be activated at a time. Frequency is converted to digital signal which is output to downstream components, i.e., for transmission to a receiver that can decode the digital signal to provide frequency readout and analysis.

Alternatively, as in FIG. 9, two separate PICs may be used: one 40 for generating the identification code of the monitored equipment, and another for the clock/timer/ counter mechanism 400. The counter 400 collects frequency/phase and or amplitude data. A switching or timing mechanism 420 polls each of the PICs, i.e., to received the identification code and then receive the frequency data up to the point of polling and modulates both pieces of data onto an RF signal for transmission to the receiver. Alternately, the counter PIC 400 can transmit its vibration data into an input pin of the encoder PIC 40. The encoder 40 may then modulate both its code and the frequency/vibration data onto the RF signal to be transmitted.

Alternately, an interrogator and transmitter may be used such that upon interception of interrogation signal, the PICs 40 and/or 400 can send code and stored frequency upon interrogation. No spurious or confused signals. E.g., with a sampling frequency of 10 ms and 100 sensors can get 100 updates per sensor per second.

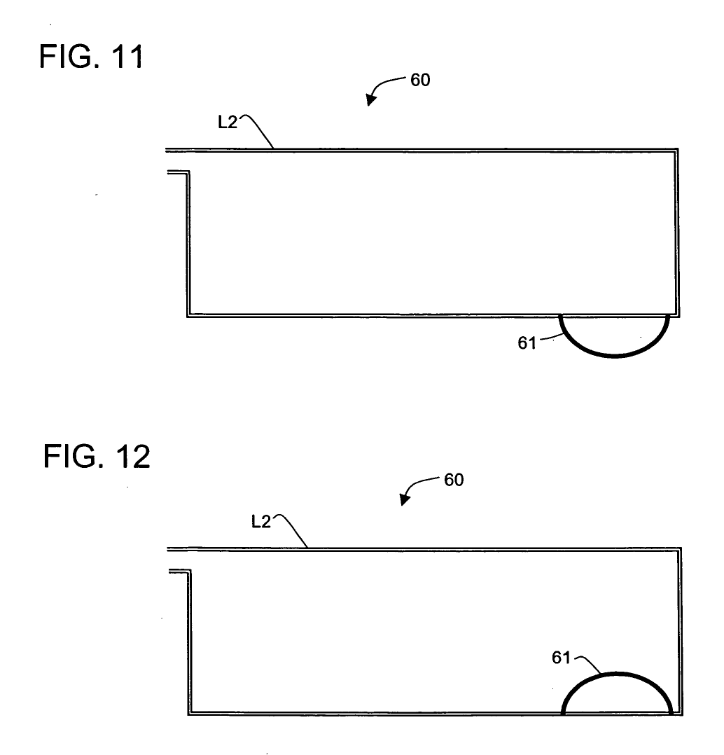

Referring now to FIGS. 11 and 12: The RF generator 50 works in conjunction with a tuned loop antenna 60. In the preferred embodiment, the inductor L2 of the tank circuit serves as the loop antenna 60. More preferably, the inductor/loop antenna L2 comprises a single rectangular loop of copper wire having an additional smaller loop or jumper 61 connected to the rectangular loop L2. Adjustment of the shape and angle of the smaller loop 61 relative to the rectangular loop L2 is used to increase or decrease the apparent diameter of the inductor L2 and thus tunes the RF transmission frequency of the RF generator 50. In an alternate embodiment, a separate tuned antenna may be connected to the second junction of the tank circuit.

In operation: The positive voltage output from the voltage regulator U2 is connected the encoder 40 and the RF choke inductor L1. The voltage drives the encoder 40 to generate a coded square wave output, which is connected to the base of the BJT Q1 through resistor R2. When the coded square wave voltage is zero, the base of the BJT Q1 remains de-energized, and current does not flow through the inductor L1. When the coded square wave voltage is positive, the base of the BJT Q1 is energized through resistor R2. With the base of the BJT Q1 energized, current is allowed to flow across the base from the collector to the emitter and current is also allowed to flow across the inductor L1. When the square wave returns to a zero voltage, the base of the BJT Q1 is again de-energized.

When current flows across the choke inductor L1, the tank circuit capacitor C8 charges. Once the tank circuit capacitor C8 is charged, the tank circuit begins to resonate at the frequency determined by the circuit's LC constant. For example, a tank circuit having a 7 picofarad capacitor and an inductor L2 having a single rectangular loop measuring 0.7 inch by 0.3 inch, the resonant frequency of the tank circuit is 310 MHz. The choke inductor L1 prevents RF leakage into upstream components of the circuit (the PIC) because changing the magnetic field of the choke inductor L1 produces an electric field opposing upstream current flow from the tank circuit. To produce an RF signal, charges have to oscillate with frequencies in the RF range. Thus, the charges oscillating in the tank circuit inductor/tuned loop antenna L2 produce an RF signal of preferably 310 MHz. As the square wave output of the inverter turns the BJT Q1 on and off, the signal generated from the loop antenna 60 comprises a pulsed RF signal having a duration of 100-250 milliseconds and a pulse width determined by the encoder 40, (typically of the order of 0.1 to 5.0 milliseconds thus producing 20 to 2500 pulses at an RF frequency of approximately 310 MHz. The RF generator section 50 is tunable to multiple frequencies. Therefore, not only is the transmitter capable of a great number of unique codes, it is also capable of generating each of these codes at a different frequency, which greatly increases the number of possible combinations of unique frequency-code signals.

The RF generator 50 and antenna 60 work in conjunction with an RF receiver 270. More specifically, an RF receiver 270 in proximity to the RF transmitter 60 (within 300 feet) can receive the pulsed RF signal transmitted by the RF generator 50. The RF receiver 270 comprises a receiving antenna 270 for intercepting the pulsed RF signal (tone or code). The tone generates a pulsed electrical signal in the receiving antenna 270 that is input to a microprocessor chip that acts as a decoder 280. The decoder 280 filters out all signals except for the RF signal it is programmed to receive, e.g., the signal generated by the RF generator 50. An external power source is also connected to the microprocessor chip/decoder 280. In response to the intercepted code from the RF generator 50, the decoder chip produces a pulsed electrical signal. The external power source connected to the decoder 280 augments the pulsed voltage output signal developed by the chip. This augmented (e.g., 120 VAC) voltage pulse is then applied to a conventional relay 290 for changing the position of a switch within the relay. Changing the relay switch position is then used to turn an electrical device with a bipolar switch on or off, or toggle between the several positions of a multiple position switch. Zero voltage switching elements may be added to ensure the relay 290 activates only once for each depression and recovery cycle of the flextensional transducer element 12.

Switch Initiator System with Trainable Receiver

Several different RF transmitters may be used that generate different codes for receivers that are tuned to receive that code. In another embodiment, digitized RF signals may be coded and programmable (as with a garage door opener) to only be received by one or more receivers that are coded with that digitized RF signal. In other words, the RF transmitter is capable of generating at least one code, but is preferably capable of generating multiple codes. Most preferably, each transmitter is programmed with one or more unique coded signals. This is easily done, since programmable ICs for generating the code can have over 2³⁰ possible unique signal codes which is the equivalent of over 1 billion codes. Most preferably the invention comprises a system of multiple transmitters and one or more receivers for receiving signals indicative of the vibrational state of a variety of pieces of equipment. In this system for vibration monitoring, an extremely large number of codes are available for the transmitters and each transmitter can have at least one unique, permanent and nonuser changeable code indicative of that particular transmitter and the vibrational state of the piece of equipment to which it is attached. The receiver and controller module at the remote or central monitoring area is capable of storing and remembering a number of different codes corresponding to different transmitters such that the controller can be programmed so as to monitor, analyze or display more than one transmitted code, thus allowing two or more transmitters to be monitored on a single monitoring device.

The remote monitoring system includes a receiver/controller for learning a unique code of a remote transmitter to monitor the vibration of the equipment with which the receiver/controller module is associated. Preferably, a plurality of transmitters is provided wherein each transmitter has at least one unique and permanent non-user changeable code and wherein the receiver can be placed into a program mode wherein it will receive and store two or more codes corresponding to two or more different transmitters. The number of codes which can be stored in transmitters can be extremely high as, for example, greater than one billion codes. The receiver has a decoder module therein which is capable of learning many different transmitted codes, which eliminates code switches in the receiver and also provides for multiple transmitters for actuating the light or appliance. Thus, the invention makes it possible to eliminate the requirements for code selection switches in the transmitters and receivers.

Referring to FIG. 8 and 9: The receiver module 101 includes a suitable antenna 270 for receiving radio frequency transmissions from one or more transmitters 126 and 128 and supplies an input to a decoder 280 which provides an output to a microprocessor unit 244. The microprocessor unit 244 is connected to a relay device 290 or controller which switches the light or appliance between one of two or more operation modes, i.e., on, off, dim, or some other mode of operation. A switch 222 is mounted on a switch unit 219 connected to the receiver and also to the microprocessor 244. The switch 222 is a two position switch that can be moved between the “operate” and “program” positions to establish operate and program modes.

In the invention, each transmitter, such as transmitters 126 and 128, has at least one unique code which is determined by the tone generator/encoder 40 contained in the transmitter. The receiver unit 101 is able to memorize and store a number of different transmitter codes which eliminates the need of coding switches in either the transmitter or receiver which are used in the prior art. This also eliminates the requirement that the user match the transmitter and receiver code switches. Preferably, the receiver 101 is capable of receiving many transmitted codes, up to the available amount of memory locations 247 in the microprocessor 244, for example one hundred or more codes.

When the remote monitoring system is initially installed, the switch 222 on the receiver is moved to the program mode and the first transmitter 126 is energized so that the unique code of the transmitter 126 is transmitted. This is received by the receiver module 101 having an antenna 270 and decoded by the decoder 280 and supplied to the microprocessor unit 244. The code of the transmitter 126 is then supplied to the memory address storage 247 and stored therein. Then if the switch 222 is moved to the operate mode and the transmitter 126 energized, the receiver 270, decoder 280 and the microprocessor 244 will compare the received code with the code of the transmitter 126 stored in the first memory location in the memory address storage 247 and since the stored memory address for the transmitter 126 coincides with the transmitted code of the transmitter 126 the microprocessor 244 forward identifying and alert information to the microprocessor and equipment controller device 290 for sending alert, alarm or shutdown signals.

In order to store the code of the second transmitter 128 the switch 222 is moved again to the program mode and the transmitter 128 is energized. This causes the receiver 270 and decoder 280 to decode the transmitted signal and supply it to the microprocessor 244 which then supplies the coded signal of the transmitter 128 to the memory address storage 247 where it is stored in a second address storage location. Then the switch 222 is moved to the operate position and when either of the transmitters 126 and 128 are energized, the receiver 270 decoder 280 and microprocessor 244. Alternately, the signal from the first transmitter 126 and second transmitter 128 may cause separate and distinct actions to be performed by the controller and/or microprocessor 244.

Thus, the codes of the transmitters 126 and 128 are transmitted and stored in the memory address storage 247 during the program mode after which the system or controller 290 will respond to either or both of the transmitters 126 and 128. Any desired number of transmitters can be programmed to operate the system up to the available memory locations in the memory address storage 247.

This invention eliminates the requirement that binary switches be set in the transmitter or receiver as is done in systems of the prior art. The invention also allows a controller to respond to a number of different transmitters because the specific codes of a number of the transmitters are stored and retained in the memory address storage 247 of the receiver module 101.

In another embodiment of the invention, receiver modules 101 may be trained to accept the transmitter code(s) in one-step. Basically, the memory 247 in the microprocessor 244 of the receiver modules 101 will have “slots” where codes can be stored. For instance one slot may be for all of the codes that the memory 247 accepts for specific transmitter or pieces of equipment.

Each transmitter 126 has a certain set of codes. Each of these codes is “unique”. The transmitter 126 sends out its code set in a way in which the receiver 101 knows in which slots to put each code. Also, with the increased and longer electrical signal that can be generated in the transmitter 126, a single transmission of a code set is achievable even with mechanically produced voltage. As a back-up, if this is not true, and if wireless transmission uses up more electricity than we have available, some sort of temporary wired connection (jumper not shown) between each transmitter and receiver target is possible. Although the disclosed embodiment shows manual or mechanical interaction with the transmitter and receiver to train the receiver, it is yet desirable to put the receiver in reprogram mode with a wireless transmission, for example a “training” code.

In yet another embodiment of the invention, the transmitter 126 may have multiple unique codes and the transmitter randomly selects one of the multitude of possible codes, all of which are programmed into the memory allocation spaces 247 of the microprocessor 244.

Furthermore, the transmitters can talk to a central system or repeater which re-transmits the signals by wire or wireless means to the central processor 244. In this manner, one can have one transmitter/receiver set, or many transmitters interacting with many different receivers, some transmitters talking to one or more receivers and some receivers being controlled by one or more transmitters, thus providing a broad system of interacting systems and wireless transmitters. Also, the transmitters and receivers may have the capacity of interfacing with wired communications like SMARTHOME or BLUETOOTH.

While in the preferred embodiment of the invention, the actuation means has been described as from mechanical to electric, it is within the scope of the invention to include batteries in the transmitter to power or supplement the power of the transmitter. For example, rechargeable batteries may be included in the transmitter circuitry and may be recharged through the electromechanical actuators. These rechargeable batteries may thus provide backup power to the transmitter.

It is seen that the present invention allows a receiving system to respond to one of a plurality of transmitters which have different unique codes which can be stored in the receiver during a program mode. Each time the “program mode switch” 222 is moved to the program position, a different storage can be connected so that the new transmitter code would be stored in that address. After all of the address storage capacity have been used additional codes would erase all old codes in the memory address storage before storing a new one.

This invention is safe because it eliminates the need for 120 VAC (220 VAC in Europe) lines to be run between each piece of equipment and the monitoring facility. Instead the higher voltage overhead AC lines are only run to the equipment, and they are monitored through the self-powered monitoring device and relay switch. The invention also saves on initial and renovation construction costs associated with cutting holes and running the electrical lines to/through each switch and within the walls.

While the above description contains many specificities, these should not be construed as limitations on the scope of the invention, but rather as an exemplification of one preferred embodiment thereof. Many other variations are possible, for example:

In addition to piezoelectric devices, the electroactive elements may comprise magnetostrictive or ferroelectric devices;

Rather than being arcuate in shape, the actuators may normally be flat and still be deformable;

Multiple high deformation piezoelectric actuators may be placed, stacked and/or bonded on top of each other;

Multiple piezoelectric actuators may be placed adjacent each other to form an array.

Larger or different shapes of thunder elements may also be used to generate higher impulses.

The piezoelectric elements may be flextensional actuators or direct mode piezoelectric actuators.

A bearing material may be disposed between the actuators and the recesses or switch plate in order to reduce friction and wearing of one element against the next or against the frame member of the switch plate.

Other means for applying pressure to the actuator may be used including simple application of manual pressure, rollers, pressure plates, toggles, hinges, knobs, sliders, twisting mechanisms, release latches, spring loaded devices, foot pedals, game consoles, traffic activation and seat activated devices.

1. A self-powered vibration monitoring system, comprising:
an electroactive transducer having first and second ends, said electroactive transducer comprising;
a first electroactive member having opposing first and second electroded major faces and first and second ends;
a flexible substrate bonded to said second major face of said first electroactive member;
said flexible substrate having first and second ends adjacent said first and second ends of said first electroactive member;
wherein said electroactive transducer is adapted to deform from a first position to a second position upon application of a force to said electroactive transducer;
and wherein said electroactive transducer is adapted to return to said first position from said second position upon release of said force from said electroactive transducer;
and wherein upon said deformation from said first position to second position, said electroactive transducer is adapted to generate a first voltage potential between said first electroded major face and said second electroded major face;
and wherein upon said return from said first position to second position, said electroactive transducer is adapted to generate a second voltage potential between said first electroded major face and said second electroded major face;
a mounting member for retaining said electroactive transducer;
said mounting member comprising at least one retaining means adjacent said first end, said second end or said first and second ends of said flexible substrate of said first electroactive member;
said mounting means being mechanically attached to a piece of equipment vibrating at a frequency;
wherein said vibrating equipment transmits a vibration through said mounting means to said electroactive transducer;
and wherein said electroactive transducer generates an oscillating voltage at said frequency of vibration of said equipment;
a first conductor electrically connected to said first electroded major face of said first electroactive member;
a second conductor electrically connected to said second electroded major face of said first electroactive member;
a rectifier having an input side and an output side;
said input side of said rectifier being electrically connected between said first and second conductors in parallel with said first and second electroded major faces of said electroactive transducer;
a voltage regulator having an input side and an output side;
said input side of said voltage regulator being electrically connected to said output side of said rectifier;
a logic component, said logic component comprising an encoder and a frequency counter;
said encoder having an input and an output side, said output side of said voltage regulator being connected to said input side of said encoder;
an output signal at said output side of said encoder being an electrical signal having a coded waveform;
said frequency counter having an input and an output side and a power connection;
said output side of said voltage regulator being connected to said power connection of said encoder;
said input side of said frequency counter being electrically connected to said first and second conductors;
an output signal at said output side of said frequency being an electrical signal having frequency data contained therein;
first signal transmission means electrically connected to said output side of said logic component;
said first signal transmission means comprising a first radio frequency generator subcircuit connected to an antenna;
said radio-frequency generator subcircuit being adapted to generate a first radio-frequency signal modulated by said output signal of said encoder and said frequency counter for transmission by said antenna; and
signal reception means for receiving a first signal transmitted by said first signal transmission means.
